(19) United States
(12) Patent Application Publication
(10) Pub. No.: US 2005/0063287 A1
(43) Pub. Date: Mar. 24, 2005

(54) Optical disk reproducing apparatus, and offset adjustment method

(76) Inventors: Atsushi Suzuki, Kanagawa (JP); Hideo Nagasaka, Kanagawa (JP); Kouji Tsukamoto, Nagasaki (JP)

Correspondence Address: ROBERT J. DEPKE LEWIS T. STEADMAN;HOLLAND & KNIGHT LLC, 131 SOUTH DEARBORN, 30TH FLOOR, CHICAGO, IL, 60603, US

(21) Appl. No.: 10/941,555

(22) Filed: Sep. 15, 2004

(30) Foreign Application Priority Data
Sep. 18, 2003 (JP) JP2003-326291

(51) Int. Cl. G11B 7/00

(52) U.S. Cl. 369/124.1; 369/44.29; 369/44.35

(57) ABSTRACT

When a gain control circuit is its maximum gain, an offset adjusting circuit generates an offset adjusting voltage so that an offset voltage included in an output signal of this gain control circuit becomes a target voltage within a dynamic range of a digital correction unit, and a control circuit adjusts an offset by adding the offset adjusting voltage to a control signal from a processing circuit in an adding circuit. In this case, a residual offset voltage included in an output signal of this gain control circuit is corrected by a digital correction unit. All of the electrical offset in the analog circuitry are not cancelled, but the offset adjustment is carried out to a range correctable by the digital correction circuit.

### BACKGROUND OF THE INVENTION

1. Filed of the Invention

This invention relates to an optical disk reproducing apparatus and to an offset adjustment method, and more particularly to an offset adjustment for an output signal reproducing circuitry of an optical pickup device installed in an optical disk reproducing apparatus.

2. Description of the Related Art

In a conventional optical disk reproducing apparatus, a signal level of signals obtained from an optical pickup device fluctuates significantly depending on a type of an optical disk and a change in its characteristic with time, etc., so that it is common to carry out an offset adjustment for an output signal reproducing circuitry of the optical pickup device installed in the optical disk reproducing apparatus.

FIG. 8 is a block diagram showing a configuration of such conventional optical disk reproducing apparatus that carries out these offset adjustment and gain adjustment. This optical disk reproducing apparatus includes an optical pickup 2, a signal processing circuit 4, an adding circuit 6, a gain control circuit 8, a control circuit 10, and an offset adjusting circuit 12.

When an optical disk is reproduced by the optical pickup 2, the signal processing circuit 4 generates servo error signals such as a focus error signal and the like that are necessary for performing a servo control, and a control signal such as RFDC signals and the like for detecting defect signals and the like based on signals picked up by the optical pickup 2. These control signals are supplied to the gain control circuit 8 in order to adjust its amplitude level after an offset adjusting voltage is added at the adding circuit 6, and then supplied to a next stage (not shown).

When a power switch is made on before starting the above mentioned reproduction of an optical disk, the control circuit 10 generates in the offset adjusting circuit 12 the offset adjusting voltage for canceling electrical offset voltages of a photo detector circuit (not shown) inside the optical pickup 2, the signal processing circuit 4, and the gain control circuit 8, and performs the offset adjustment by adding this offset adjusting voltage to the control signal at the adding circuit 6.

In the configuration example of the optical disk reproducing apparatus as shown in FIG. 8, the offset adjustment and the gain adjustment are performed as follows. That is, at first a servo system (not shown) of the optical pickup 2 is made off, and a difference between an output level from the gain control circuit 8 and a previously determined reference level is detected by the control circuit 10. Then, an offset adjusting voltage corresponding to the difference (offset voltage) is generated in the offset adjusting circuit 12, and this offset adjusting voltage is added to the output control signal from the signal processing circuit 4 for canceling the offset. After that, the gain adjustment for the gain control circuit 8 is performed so that the control signal outputted from the signal processing circuit 4 becomes an optimum amplitude level.

However, because there exists an electrical offset in a photo detector circuit (not shown) included in the optical pickup 2 and also in the signal processing circuit 4, when the gain adjustment is performed in the gain control circuit 8 after the offset adjustment is performed, the output offset tends to fluctuate. Accordingly, it was necessary to perform the offset adjustment at every time when the gain adjustment was carried out by the gain control circuit 8, but this took much time and accordingly, there was a problem in which a response of the optical disk reproducing apparatus was deteriorated.

Then, in order to solve the problem as mentioned above, there is reported a conventional technology in which an offset Voff1 when the gain control circuit 8 is set to a first gain G1 and an offset Voff2 when the gain control circuit 8 is set to a second gain G2 are measured, then a total offset from the optical pickup 2 to the gain control circuit 8 is obtained by calculating (Voff1−Voff2)/(G1−G2), thus obtained total offset is used as the offset adjusting voltage, and it becomes possible to eliminate the offset adjustment even the gain of the gain control circuit 8 is changed. For example, see Patent Document JP-2000-285480

However, the above mentioned conventional offset adjustment method is able to eliminate the offset adjustment in the gain control circuit 8 when the gain thereof is changed, but still, some offset tends to be included in a focus error signal, so that it is necessary to perform a second offset adjustment for canceling such residual offset. Further, there is another problem in which it is necessary to carry out measurements for offset voltages at two gain points of the gain control circuit 8 to perform the first offset adjustment, so that the offset adjustment becomes not so easy.

### SUMMARY OF THE INVENTION

This invention was conceived in consideration of the above problems, and aspects of the present invention is to propose an optical disk reproducing apparatus and an offset adjustment method, wherein a response of the optical disk reproducing apparatus upon reproducing is improved by carrying out the offset adjustment for the analog circuit simply and by only one time.

This invention is an optical disk reproducing apparatus having a gain control circuit for adjusting an amplitude of a control signal generated based on a signal from an optical pickup device, and offset correcting means for canceling an offset voltage included in an output signal from the gain control circuit in order to attain the above aspects of the present invention. The optical disk reproducing apparatus of the present invention further includes offset adjustment means for adjusting an offset voltage included in an output signal from the gain control circuit, wherein the offset adjustment means is characterized to include offset adjusting voltage generation means for generating an offset adjusting voltage which becomes a target voltage within a dynamic range of the gain control circuit when the gain control circuit is in its maximum gain, and adding means for adding thus generated offset adjusting voltage to either a control signal or a signal outputted from the above mentioned optical pickup device.

A described above, in the optical disk reproducing apparatus of the present invention, the electrical offset from the optical pickup device to the gain control circuit is adjusted by generating the offset adjusting voltage which makes the offset voltage included in the output signal of the gain control circuit to be the target voltage within the dynamic range of the offset correcting means, and accordingly, even if the gain of the gain control circuit is changed thereafter, the offset voltage included in the output signal from the gain control circuit always falls within the target voltage range, and the offset voltage outputted from the gain control circuit after the gain is changed becomes within the dynamic range of the offset correcting means. Therefore, the offset correcting means is able to cancel, without serious problem, the offset voltage outputted from the gain control circuit irrespective of its gain. As described above, all of the electrical offsets from the optical pickup device to the gain control circuit are not canceled, but the offset adjustment for suppressing the electrical offsets within a range correctable by the offset correcting means suppressed is carried out. Accordingly, if the electrical offset from the optical pickup device to the gain control circuit is adjusted and corrected once, even the gain of the gain control circuit is changed thereafter, it is not necessary to adjust the electrical offset again, it is able to improve the response of the optical disk reproducing apparatus, and it is able to simply carry out the above mentioned offset adjustment by only one time.

Further, the present invention is an optical disk reproducing apparatus which comprises a gain control circuit for adjusting an amplitude of a control signal generated from a signal outputted from an optical pickup device, a fixed gain amplifier for amplifying the amplitude-adjusted control signal, and offset correcting means for canceling an offset voltage included in an output signal from the fixed gain amplifier, wherein the optical disk reproducing apparatus further comprises offset adjustment means for adjusting an offset voltage included in an output signal of the gain control circuit, and this offset adjustment means includes offset adjusting voltage generating means for generating an offset adjusting voltage wherein an offset voltage included in an output of the fixed gain amplifier becomes a target voltage within a dynamic range of the offset correcting means when the gain control circuit is in the maximum gain, and adding means for adding thus generated offset adjusting voltage to either the control signal or a signal outputted from the optical pickup, and in this case, the fixed gain amplifier is designed to have a smaller offset voltage than an absolute value of the target voltage.

A described above, in the optical disk reproducing apparatus of the present invention, the electrical offset from the optical pickup device to the gain control circuit is adjusted by generating the offset adjusting voltage which makes the offset voltage included in the output signal of the fixed gain amplifier circuit to be the target voltage within the dynamic range of the offset correcting means, and if the fixed gain amplifier circuit having a specification wherein the offset voltage inherent to this amplifier circuit becomes smaller than an absolute value of the target voltage, then, even if the gain of the gain control circuit is changed thereafter, the offset voltage included in the output signal from the fixed gain amplifier circuit always falls within the target voltage range, and the offset voltage outputted from the fixed gain amplifier circuit after the gain is changed becomes within the dynamic range of the offset correcting means. Therefore, the offset correcting means is able to cancel, without serious problem, the offset voltage outputted from the fixed gain amplifier circuit irrespective of the gain of the gain control circuit. As described above, all of the electrical offsets from the optical pickup to the fixed gain amplifier circuit are not canceled, but the offset adjustment for suppressing the electrical offsets within a range correctable by the offset correcting means suppressed is carried out. Accordingly, if the electrical offset from the optical pickup to the fixed gain amplifier circuit is adjusted and corrected once, even the gain of the gain control circuit is changed thereafter, it is not necessary to adjust the electrical offset, it is able to improve the response of the optical disk reproducing apparatus, and it is able to simply carry out the above mentioned offset adjustment by only one time.

Further, this invention is an offset adjustment method in a circuitry having, at its final stage, an analog circuit including a gain control circuit for adjusting a signal amplitude, and offset correcting means for canceling an offset voltage included in an analog signal outputted from the analog circuit, wherein the offset adjustment of the analog circuit is carried out so that the offset voltage outputted from the analog circuit becomes a target voltage within a dynamic range of the offset correcting means when the gain control circuit is in its maximum gain.

A described above, in the offset adjustment method of the present invention, the electrical offset included in the analog circuit unit is adjusted by generating the offset adjusting voltage which makes the offset voltage included in the output signal of the analog circuit unit to be the target voltage within the dynamic range of the offset correcting means, and accordingly, even if the gain of the gain control circuit is changed thereafter, the offset voltage included in the output signal from the analog circuit unit always falls within the target voltage range, and the offset voltage outputted from the analog circuit unit after the gain is changed becomes within the dynamic range of the offset correcting means. Therefore, the offset correcting means is able to cancel, without serious problem, the offset voltage outputted from the analog circuit unit irrespective of its gain. As described above, all of the electrical offsets of the analog circuit unit are not canceled, but the offset adjustment for suppressing the electrical offsets within a range correctable by the offset correcting means suppressed is carried out. Accordingly, if the electrical offset of the analog circuit unit is adjusted and corrected once, even the gain of the gain control circuit is changed thereafter, it is not necessary to adjust the electrical offset, it is able to improve the response of the circuit unit, and it is able to simply carry out the above mentioned offset adjustment by only one time.

Further, the present invention is an offset adjustment method in a circuitry having a gain control circuit for adjusting an amplitude level of a signal, an analog circuit unit including, at its final stage, a fixed gain amplifier circuit connected to an output side of the gain control circuit, and offset correcting means for canceling an offset voltage included in an analog signal outputted from the analog circuit unit, wherein the offset adjustment for the analog circuit unit is carried out so that the offset voltage outputted from the analog circuit becomes a target voltage within a dynamic range of the offset correcting means when the gain control circuit is in its maximum gain, and in this case, the fixed gain amplifier is designed to have a smaller offset voltage than an absolute value of the target voltage.

A described above, in the offset adjustment method of the present invention, the electrical offset included in the analog circuit unit is adjusted by generating the offset adjusting voltage which makes the offset voltage included in the output signal of the analog circuit unit to be the target voltage within the dynamic range of the offset correcting means, and if the fixed gain amplifier circuit having a specification wherein the offset voltage inherent to this amplifier circuit becomes smaller than an absolute value of the target voltage, then, even if the gain of the gain control circuit is changed thereafter, the offset voltage included in the output signal from the analog circuit unit always falls within the target voltage range, and the offset voltage outputted from the analog circuit unit after the gain is changed becomes within the dynamic range of the offset correcting means. Therefore, the offset correcting means is able to cancel, without serious problem, the offset voltage outputted from the analog circuit unit irrespective of its gain. As described above, all of the electrical offsets of the analog circuit unit are not canceled, but the offset adjustment for suppressing the electrical offsets within a range correctable by the offset correcting means suppressed is carried out. Accordingly, if the electrical offset of the analog circuit unit is adjusted and corrected once, even the gain of the gain control circuit is changed thereafter, it is not necessary to adjust the electrical offset, it is able to improve the response of the circuit unit, and it is able to simply carry out the above mentioned offset adjustment by only one time.

As described above in detail, according to the present invention, electrical offsets of the analog circuit are not cancelled all, but the electrical offset is suppressed within a range correctable by the offset correction means at following stage of the analog circuit, and by correction the residual offset in a digital processing manner at the offset correcting means, the offset adjustment for the analog circuit can be performed in a short time and by only one time, thereby the response of the apparatus upon reproducing is able to be improved.

### BRIEF DESCRIPTION OF THE DRAWINGS

FIG. 1 is a block diagram showing a first embodiment of an optical disk reproducing apparatus according to the present invention;

FIG. 2 is an equivalent circuit of the apparatus shown in FIG. 1;

FIG. 3 is a block diagram showing a second embodiment of the optical disk reproducing apparatus according to the present invention;

FIG. 4 is an equivalent circuit of the apparatus shown in FIG. 3;

FIG. 5 is a block diagram showing a third embodiment of the optical disk reproducing apparatus according to the present invention;

FIG. 6 is an equivalent circuit of the apparatus shown in FIG. 5;

FIG. 7 is a chart showing an area where a final offset voltage in an equivalent circuit in FIG. 5 is within a target offset voltage; and

FIG. 8 is a block diagram showing one example of a conventional optical disk reproducing apparatus.

### DESCRIPTION OF THE PREFERRED EMBODIMENT

In order to improve a response of an optical disk reproducing apparatus upon reproducing, an offset adjustment for an analog circuit is carried out in a short time and by only one time. The present invention is able to realize this purpose by adjusting an electrical offset from an optical pickup to a gain control circuit so that an offset voltage included in an output signal from the gain control circuit becomes a target voltage within a dynamic range of offset correction means.

First Embodiment:

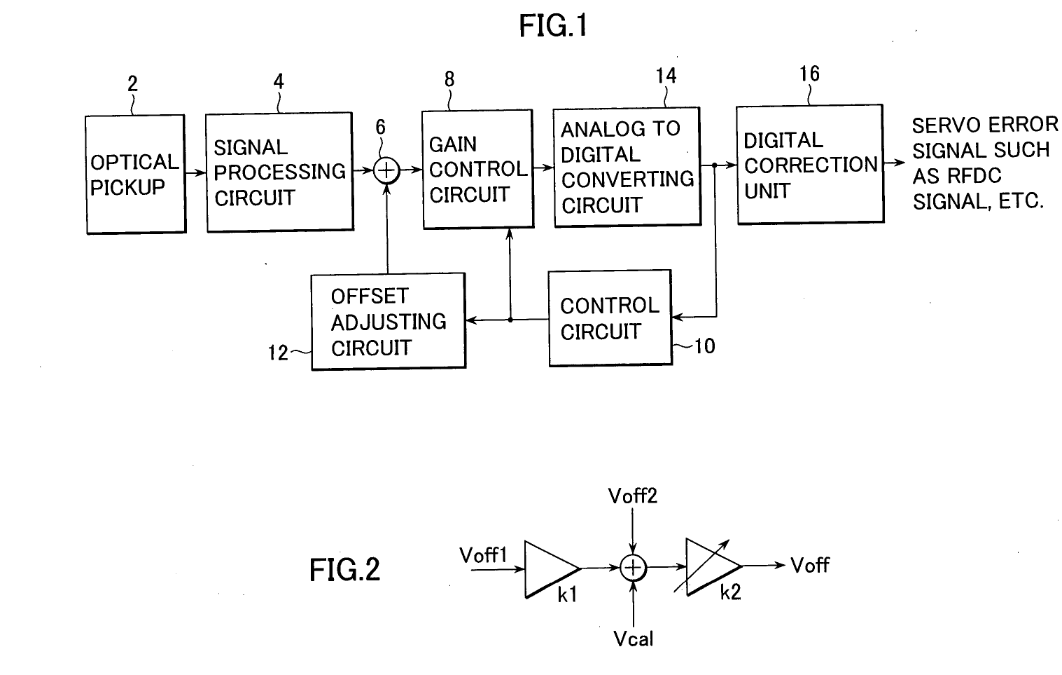

FIG. 1 is a block diagram showing a configuration of a first embodiment of an optical disk reproducing apparatus according to the present invention. In this case, the same portions appeared in the conventional example are described using the same reference codes. An optical disk reproducing apparatus includes an optical pickup 2, a signal processing circuit 4, an adding circuit 6, a gain control circuit 8, a control circuit 10, an offset adjusting circuit 12, an analog to digital conversion circuit 14, and a digital correction unit 16. In this case, a gain control circuit corresponds to the gain control circuit 8, offset correction means corresponds to the digital correction unit 16, offset adjusting voltage generating means corresponds to the offset adjusting circuit 12, and adding means corresponds to the adding circuit 6 in the appended claims.

Now, an operation of a first embodiment of the present invention is described. When an optical disk is reproduced, a signal picked up by the optical pickup 2 is processed in the signal processing circuit 4, and becomes servo error signals such as a focus error signal necessary for servo control, and control signals such as an RFDC signal for detecting defect signals. After an offset adjusting voltage is added in the adding circuit 6, these control signals are amplified in the gain control circuit 8 so that their amplitudes become optimum. These control signals having optimum amplitudes by the operation of the gain control circuit 8 are converted into digital signals in the analog to digital conversion circuit 14, and these digital signals are inputted to the digital correction unit 16 and the control circuit 10.

The control circuit 10 monitors the digital signals outputted from the analog to digital conversion circuit 14, calculates electrical offset voltages of a photo detector circuit (not shown) in the optical pickup 2, the signal processing circuit 4, and the gain control circuit 8, makes the offset adjusting circuit 12 generate offset adjusting voltage signal processing circuit 4 for canceling this offset voltage, and adds to the output signal from the signal processing circuit 4 by outputting the offset adjusting voltage to the adding circuit 6. Thereby, the control circuit 10 adjusts the electrical offset up to the gain control circuit 8 to be within the target voltage range, that is, a range where a digital correction by the digital correction unit 16 is possible.

A residual component of the electrical offset voltage by the above mentioned offset adjustment and a displacement of an optimum servo point caused by optical reasons are corrected by an offset canceling processing by inputting the control signal digitized in the analog to digital conversion circuit 14 to the digital correction unit 16, and outputted to a next stage.

Now, an offset adjustment operation of the circuit shown in FIG. 1 using the equivalent circuit shown in FIG. 2 is described. In this case, in FIG. 2, Voff1 designates a value obtained by adding an output offset value of a photo detector circuit IC (not shown) in the optical pickup 2 and an input converted offset voltage value of the signal processing circuit 4, k1 designates a fixed gain value as a gain of the signal processing circuit 4, Voff2 designates an input converted offset voltage value of the gain control circuit 8, and k2 designates a variable value as a gain of the gain control circuit 8, respectively. Further, Vcal designates an offset adjusting voltage outputted from the offset adjusting circuit 12, and Voff designates an ultimate output offset value.

In the case shown in FIG. 2, the Voff is expressed by following Formula (1).
Voff=k1·k2·Voff1+k2·Voff2+k2·Vcal (1)

Then, the Vcal is adjusted so that the output offset at the time when the k2 is a maximum gain k2max becomes an offset voltage Voffmax within a target offset voltage value. The Vcal at this time is expressed by following Formula (2).

$$\begin{matrix}Voffmax = k1 \cdot k2 max \cdot Voff1 + k2 max \cdot Voff2 + k2 max \cdot Vcal \\ Vcal = \frac{Voff max}{k2 max} - k1 \cdot Voff1 - Voff2\end{matrix} \qquad ( 2 )$$

The offset adjustment is carried out by adding the offset adjusting voltage Vcal given by the Formula (2) to an output of the k1, and after that, the gain is changed to the k2. The offset voltage Voff at this moment is expressed by following Formula (3) obtained by putting Formula (2) into Formula (1).

$$\begin{matrix}Voff = k1 \cdot k2 \cdot Voff1 + k2 \cdot Voff2 + \\ k2 \cdot ( \frac{Voff max}{k2 max} - k1 \cdot Voff1 - Voff2 ) \\ Voff = Voff max \cdot \frac{k2}{k2 max}\end{matrix} \qquad ( 3 )$$

As k2<k2max, a condition of |Voff|<|Voffmax| is always established based on the Formula (3). That is, in the apparatus as shown in the equivalent circuit as shown in FIG. 2, if the offset adjustment is carried out to be within the target voltage range at the maximum gain of the gain control circuit 8, it does not become the out of the target voltage range even the gain is reduced.

According to this first embodiment, if the offset adjustment is carried out so that the electrical offset voltage at an input of the analog to digital conversion circuit 14 becomes within a range of ±Voffmax when the gain control circuit 8 is in the maximum gain, and thereafter, even though when the gain adjustment for the gain control circuit 8 is carried out, the offset voltage value changes but becomes always |Voff|<|Voffmax|, and accordingly, if the range of ± Voffmax is set to be smaller than an input dynamic range of the analog to digital conversion circuit 14, the electrical offset voltage remaining within a range of ± Voffmax is able to be adjusted by the digital correction unit 16 together with a correction of displacement of a servo optimum point caused thereafter by optical reason. On this account, by carrying out the above mentioned offset adjustment by only one time, thereafter, it becomes not necessary to carry out further offset adjustment even the gain adjustment by the gain control circuit 8 is carried out, and it becomes possible to improve the response of the optical disk reproducing apparatus. Further in the above mentioned offset adjustment, the offset voltage Vcal outputted from the offset adjusting circuit 12 is preferably adjusted by the control circuit 10 so that the output offset at the maximum gain k2max of the gain control circuit 8 becomes the offset voltage Voffmax, and thereby, the above mentioned offset adjustment is able to be carried out very simply.

Second Embodiment:

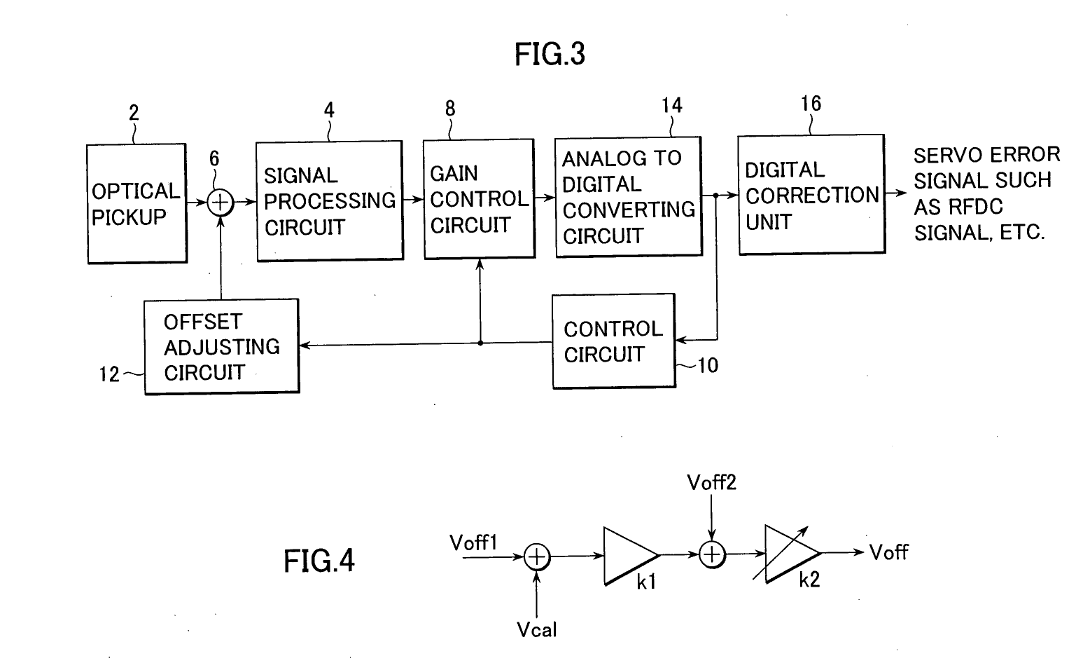

FIG. 3 is a block diagram designating a configuration of an optical disk reproducing apparatus according to a second embodiment of the present invention. In this case, the same reference codes are assigned to portions identical to the first embodiment shown in FIG. 1, and their description is omitted. The optical disk reproducing apparatus of this embodiment has a configuration wherein the offset voltage outputted from the offset adjusting circuit 12 is applied to an input side of the signal processing circuit 4, and only the position for inputting the offset voltage is different from that in the first embodiment, but other configuration is similar and, accordingly it operates in the same manner.

Then, an offset adjustment operation of the second embodiment of the present invention is described using an equivalent circuit shown in FIG. 4. In this case, the Voff is expressed by following Formula (4).
Voff=k1·k2·(Voff1+Vcal)+k2·Voff2 (4)

In this case, Vcal is adjusted so that the output offset when the k2 is the maximum gain k2max becomes the offset voltage Voffmax within the target offset voltage value. The Vcal at this time is expressed by following Formula (5).

$$\begin{matrix}Voff max = k1 \cdot k2 max \cdot ( Voff1 + Vcal ) + k2 max \cdot Voff2 \\ Vcal = \frac{Voff max}{k1 \cdot k2 max} - Voff1 - \frac{Voff2}{k1}\end{matrix} \qquad ( 5 )$$

After the offset adjustment is carried out by adding the offset adjusting voltage Vcal given by this Formula (5), the gain is changed to k2. The offset voltage Voff at this time is expressed by following Formula (6) obtained by putting Formula (5) into Formula (4).

$$Voff = k1 \cdot k2 \cdot ( Voff1 + \frac{Voff max}{k1 \cdot k2 max} - Voff1 - \frac{Voff2}{k1} ) + k2 \cdot Voff2 \\ Voff = Voff max \cdot \frac{k2}{k2 max} \qquad ( 6 )$$

As k2<k2max, so that |Voff|<|Voffmax| is always established by Formula (6). That is, in the apparatus by the equivalent circuit shown in FIG. 4, if the offset adjustment is performed to be within the target voltage range at the maximum gain of the gain control circuit 8, the offset adjustment does not go out of the target voltage range even when the gain is reduced.

According to the second embodiment, like the first embodiment, by performing the offset adjustment wherein the electrical offset voltage at the analog to digital conversion circuit 14 becomes within the ±Voffmax when the gain of the gain control circuit 8 shows the maximum gain, the same effect as in the first embodiment is expected.

Third Embodiment:

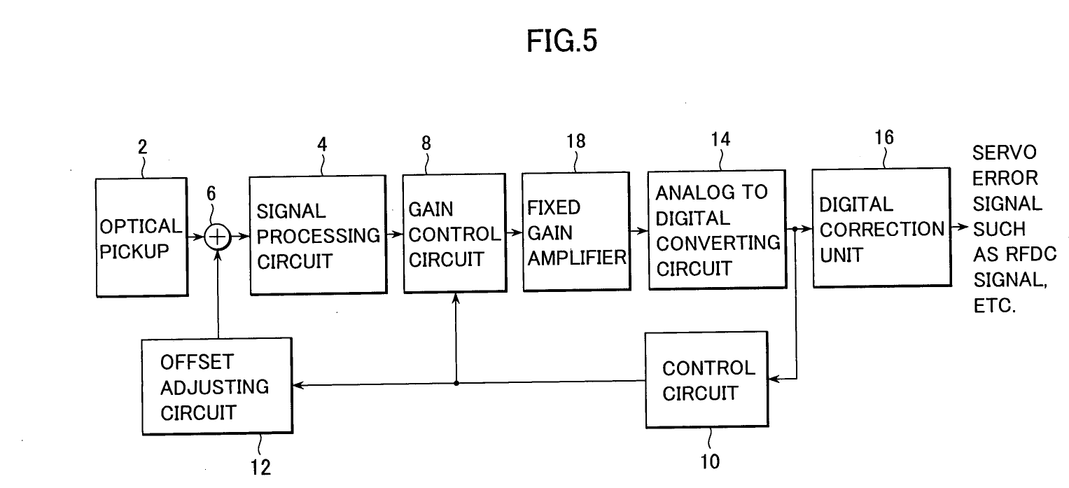

FIG. 5 is a block diagram showing a configuration of an optical disk reproducing apparatus according to a third embodiment of the present invention. In this case, the same reference codes are assigned to portions identical to the first embodiment shown in FIG. 1, and their description is omitted. The optical disk reproducing apparatus of this embodiment have approximately the same configuration as the second embodiment shown in FIG. 3, but the point that the fixed gain amplifier 18 is put between the gain control circuit 8 and the analog to digital conversion circuit 14 is different, but the operation is the same. In this case, the fixed gain amplifier circuit in the appended claims corresponds to the fixed gain amplifier 18.

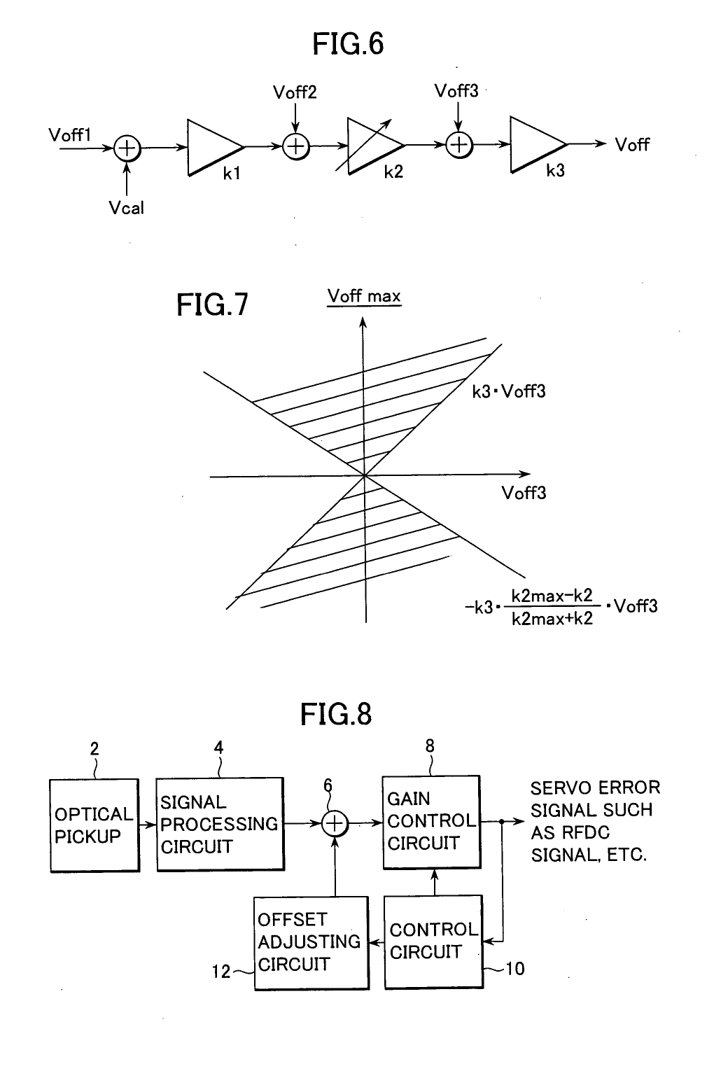

Next, an offset adjustment operation in the third embodiment is described with an equivalent circuit shown in FIG. 6. In this case, Voff3 in FIG. 6 is an input conversion offset voltage of the fixed gain amplifier 18, and k3 shows a gain of the fixed gain amplifier 18. That is, the Voff is expressed by following Formula (7).

Voff=k1·k2·k3·(Voff1+Vcal)+k2·k3·Voff2+k3·Voff3 (7)

Then, similarly, the Vcal is adjusted so that an output offset when the k2 is the maximum gain k2max becomes the offset voltage Voffmax within the target offset voltage value. The Vcal at this time is expressed by following Formula (8).

$$Voff max = k1 \cdot k2 max \cdot k3 \cdot ( Voff1 + Vcal ) + k2 max \cdot k3 \cdot Voff2 + k3 \cdot Voff3 \\ Vcal = \frac{Voff max}{k1 \cdot k2 max \cdot k3} - Voff1 - \frac{Voff2}{k1} - \frac{Voff3}{k1 \cdot k2 max} \qquad ( 8 )$$

A following Formula (9) is obtained by putting Formula (8) into Formula (7).

$$Voff = \frac{k2}{k2 max} \cdot Voff max + k3 \cdot Voff3 \cdot ( 1 - \frac{k2}{k2 max} ) \qquad ( 9 )$$

The Formula (9) shows the offset voltage when the gain of the gain control circuit 8 is changed to k2. As apparent from this Formula (9), a condition of |Voff|<|Voffmax| is not always established in this embodiment. The range where a condition of |Voff|<|Voffmax| is established becomes a range expressed by Formula (10) when Voffmax>0, and a range expressed by Formula (11) when Voffmax<0.

$$\begin{matrix}- Voff max < \frac{k2}{k2 max} \cdot Voff max + k3 \cdot Voff3 \cdot ( 1 - \frac{k2}{k2 max} ) < Voff max & ( 10 ) \\ Voff max < \frac{k2}{k2max} \cdot Voff max + k3 \cdot Voff3 \cdot ( 1 - \frac{k2}{k2 max} ) < - Voff max & ( 11 )\end{matrix}$$

From these Formula (10), and Formula (11), when Voffmax>0, a condition of −(k2max+k2)/(k2max−k2)/Voffmax k2(k2max+k2)/(k2max−k2) Voffmax<k3Voff3<Voffmax is satisfied.

If Voffmax<0, a condition of |Voff|<|Voffmax| is satisfied within a range of Voffmax<k3·Voff3<−(k2max+k2)/(k2max−k2) Voffmax (a portion with slanted lines in FIG. 7). In this case, as (k2max+k2)/(k2max−k2)>1, so that if |Voffmax|>|k3·Voff3|, then |Voff|<|Voffmax| is always satisfied. Accordingly, in an apparatus in which the fixed gain amplifier 18 is put after the gain control circuit 8, the condition of |Voff|<|Voffmax| is always satisfied, provided that the fixed gain amplifier 18 connected to the last stage is designed to have an inherent offset voltage, that is, k3·Voff3 made less than ±Voffmax.

According to the third embodiment, similar to the first embodiment, it is able to obtain the same effect as that of the by carrying out the offset adjustment so that the electrical offset voltage at an input of the analog to digital conversion circuit 14 becomes within ±Voffmax when the gain control circuit 8 is in the maximum gain.

In this case, the third embodiment has a configuration wherein the offset adjustment is carried out by adding offset the adjusting voltage outputted from the offset adjusting circuit 12 to the output signal of the optical pickup 2, but if such configuration wherein the offset adjustment is carried out by adding the adjusting voltage to the output signal of the signal processing circuit 4, the same effect is expected.

Further, the present invention is not limited to the above described embodiments, and is able to be implemented with various modified forms specifically in configuration, function, operation, and effect within scope of this patent defined by the appended claims. For example, in the above mentioned embodiment, the present invention is applied to a reproducing circuit of an optical disk reproducing apparatus, but the present invention is able to apply a circuit for processing an output signal from another electric parts having an offset other than the electrical offset such as the optical pickup, provided that the circuit has another offset correction means at its last stage.

This application claims priority from Japanese Priority Document No. 2003-326291, filed on Sep. 18, 2003 with the Japanese Patent Office, which document is hereby incorporated by reference.

1. An optical disk reproducing apparatus having a gain control circuit for adjusting an amplitude of a control signal generated based on a signal from an optical pickup device, and offset correcting means for canceling an offset voltage included in an output signal from the gain control circuit, said optical disk reproducing apparatus further comprising:
offset adjustment means for adjusting an offset voltage included in an output signal from the gain control circuit, wherein said offset adjustment means includes;
offset adjusting voltage generation means for generating an offset adjusting voltage which becomes a target voltage within a dynamic range of the gain control circuit when the gain control circuit is in its maximum gain; and
adding means for adding thus generated offset adjusting voltage to one of a control signal and a signal outputted from said optical pickup device.

2. The optical disk reproducing apparatus as cited in claim 1, wherein;
said offset adjustment means carries out an offset correction processing to a digital signal obtained by digital converting the output signal from the gain control circuit.

3. An optical disk reproducing apparatus having a gain control circuit for adjusting an amplitude of a control signal generated from a signal outputted from an optical pickup device, a fixed gain amplifier for amplifying the amplitude-adjusted control signal, and offset correcting means for canceling an offset voltage included in an output signal from the fixed gain amplifier, said optical disk reproducing apparatus further comprising:
offset adjustment means for adjusting an offset voltage included in an output signal of the gain control circuit; wherein said offset adjustment means includes;
offset adjusting voltage generating means for generating an offset adjusting voltage wherein the offset voltage included in the output of the fixed gain amplifier becomes a target voltage within a dynamic range of the offset correcting means when the gain control circuit is in the maximum gain; and
adding means for adding thus generated offset adjusting voltage to one of the control signal and the signal outputted from the optical pickup, wherein;
said fixed gain amplifier is designed to have a smaller offset voltage than an absolute value of the target voltage.

4. The optical disk reproducing apparatus as cited in claim 1, wherein;
said offset adjustment means carries out an offset correction processing to a digital signal obtained by digital converting the output signal from the fixed gain amplifier.

5. An offset adjustment method in a circuitry having, at its final stage, an analog circuit including a gain control circuit for adjusting a signal amplitude, and offset correcting means for canceling an offset voltage included in an analog signal outputted from the analog circuit, said method comprising:
a step for carrying out an offset adjustment of the analog circuit so that the offset voltage outputted from the analog circuit becomes a target voltage within a dynamic range of the offset correcting means when the gain control circuit is in its maximum gain.

6. An offset adjustment method in a circuitry having a gain control circuit for adjusting an amplitude level of a signal, an analog circuit unit including, at its final stage, a fixed gain amplifier circuit connected to an output side of the gain control circuit, and offset correcting means for canceling an offset voltage included in an analog signal outputted from the analog circuit unit; said method comprising:
a step for carrying out an offset adjustment of the analog circuit unit so that the offset voltage outputted from the analog circuit becomes a target voltage within a dynamic range of the offset correcting means when the gain control circuit is in its maximum gain, wherein;
said fixed gain amplifier is designed to have a smaller offset voltage than an absolute value of the target voltage.

7. The offset adjustment method as cited in claim 5 or 6, wherein;
said offset adjustment is carried out by adding said offset adjustment to an input stage of the gain control circuit.

8. The offset adjustment method as cited in claim 5 or 6, wherein;
said offset adjustment is carried out by adding said offset adjustment to an input stage of a circuit provided at previous stage of the gain control circuit.

9. The offset adjustment method as cited in claim 5 or 6, wherein;
said offset adjustment means carries out an offset correction processing to a digital signal obtained by digital converting the output signal from the analog circuit unit.
